(19) United States
(12) Patent Application Publication
(10) Pub. No.: US 2026/0046008 A1
(43) Pub. Date: Feb. 12, 2026

(54) METHOD AND APPARATUS FOR EARLY BEAM MANAGEMENT IN COMMUNICATION SYSTEM

(71) Applicant: Electronics and Telecommunications Research Institute, Daejeon (KR)

(72) Inventors: Yong Sun KIM, Daejeon (KR); Kapseok CHANG, Daejeon (KR); Young Jo KO, Daejeon (KR)

(73) Assignee: Electronics and Telecommunications Research Institute, Daejeon (KR)

(21) Appl. No.: 19/290,539

(22) Filed: Aug. 5, 2025

(30) Foreign Application Priority Data
Aug. 9, 2024 (KR) 10-2024-0107143
Sep. 25, 2024 (KR) 10-2024-0129976
Jul. 30, 2025 (KR) 10-2025-0104577

(51) Int. Cl. H04B 7/06

(52) U.S. Cl. CPC H04B 7/06952; H04B 7/0626

(57) ABSTRACT

The present disclosure relates to an early beam management technique in a communication system. According to the present disclosure, a method of a terminal may comprise: receiving at least one signal from at least one candidate base station; transmitting a first signal strength measurement result for the at least one signal to a source base station; performing early downlink (DL) beam management for one candidate base station selected among the at least one candidate base station based on the first signal strength measurement result; and performing uplink (UL) beam management with the one candidate base station.

### CROSS-REFERENCE TO RELATED APPLICATIONS

This application claims priority to Korean Patent Applications No. 10-2024-0107143, filed on Aug. 9, 2024, No. 10-2024-0129976, filed on Sep. 25, 2024, and No. 10-2025-0104577, filed on Jul. 30, 2025, with the Korean Intellectual Property Office (KIPO), the entire contents of which are hereby incorporated by reference.

### BACKGROUND

### 1. Technical Field

The present disclosure relates to an early beam management technique in a communication system, and more particularly, to an early beam management technique in a communication system, which enables early beam management before performing cell switching in a low-layer triggered mobility method.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In such a communication system, a terminal may move from a serving cell to a non-serving cell and may use, for example, a lower-layer triggered mobility (LTM) method introduced in 3GPP Release 18 (Rel-18). In the LTM method, the terminal may receive a cell switch command from a base station. The terminal may release a connection with the source base station and may perform a procedure for connection with a target cell by applying the target cell configuration. The terminal may be connected to the target cell through downlink and uplink beamforming procedures. A terminal that has acquired early synchronization may also need downlink and uplink beamforming procedures to be connected to the target cell. As such, the terminal may need a beam management procedure for data transmission and reception with the target cell, and may require time to proceed with the beam management procedure.

### SUMMARY

The present disclosure for resolving the above-described problems is directed to providing early beam management methods and apparatuses in a communication system, which enable early beam management before performing cell switching in a low-layer triggered mobility method.

An early beam management method according to a first exemplary embodiment of the present disclosure, performed by a terminal, may comprise: receiving at least one signal from at least one candidate base station; transmitting a first signal strength measurement result for the at least one signal to a source base station; performing early downlink (DL) beam management for one candidate base station selected among the at least one candidate base station based on the first signal strength measurement result; and performing uplink (UL) beam management with the one candidate base station.

The performing of the early DL beam management for the one candidate base station may comprise: receiving, from the source base station, channel state information-reference signal (CSI-RS) configuration information of the one candidate base station selected based on the first signal strength measurement result; receiving at least one CSI-RS from the one candidate base station according to the CSI-RS configuration information; measuring a signal strength for the at least one CSI-RS; transmitting a second signal strength measurement result for the at least one CSI-RS to the source base station; and receiving, from the source base station, a beam index of a best CSI-RS selected based on the second signal strength measurement result.

The performing of the UL beam management with the one candidate base station may comprise: receiving, from the source base station, a sounding reference signal (SRS) transmission request message including scheduling information and a sequence index for SRS transmission; transmitting at least one SRS to the one candidate base station; and receiving, from the source base station, information on a beam index of one SRS selected among the at least one SRS.

The receiving of the information on the beam index of the one SRS selected among the at least one SRS may comprise: receiving at least one of a radio resource control (RRC) message or a medium access control (MAC) control element (CE) of a cell switch command including the information on the beam index of the one SRS.

The method may further comprise: receiving, from the source base station, a cell switch command including a unified transmission configuration index (TCI) state configured as a joint UL/DL TCI state identifier; performing cell switching to the one candidate base station; and transmitting and receiving signals with the one candidate base station using the joint UL/DL TCI state identifier.

An early beam management method according to a second exemplary embodiment of the present disclosure, performed by a source base station, may comprise: receiving, from a terminal, a first signal strength measurement result of at least one candidate base station; determining, based on the first signal strength measurement result, to perform early beam management for one candidate base station selected among the at least one candidate base station; performing downlink (DL) beam management with the terminal and the one candidate base station; and performing uplink (UL) beam management with the terminal and the one candidate base station.

The determining to perform early beam management for the one candidate base station selected among the at least one candidate base station may comprise: selecting, based on the first signal strength measurement result, the one candidate base station among the at least one candidate base station to which movement of the terminal is expected; determining whether the one candidate base station is an inter-central unit (CU) cell; and based on determining that the one candidate base station is an inter-CU cell, determining to perform early beam management.

The performing of the DL beam management with the terminal and the one candidate base station may comprise: transmitting, to the one candidate base station, a channel state information-reference signal (CSI-RS) transmission request message for the DL beam management; receiving, from the one candidate base station, a response message including CSI-RS configuration information in response to the CSI-RS transmission request message; transmitting the CSI-RS configuration information to the terminal; receiving, from the terminal, a second signal strength measurement result measured for at least one CSI-RS of the one candidate base station based on the CSI-RS configuration information; selecting, based on the second signal strength measurement result, a best CSI-RS among the at least one CSI-RS; and delivering a beam index of the best CSI-RS to the one candidate base station.

The performing of the UL beam management with the terminal and the one candidate base station may comprise: transmitting, to the one candidate base station, a sounding reference signal (SRS) transmission request message for the UL beam management; receiving, from the one candidate base station, a response message including scheduling information and a sequence index for SRS reception in response to the SRS transmission request message; receiving, from the one candidate base station, information on a beam index of one SRS selected among at least one SRS transmitted from the terminal; and delivering the information on the beam index of the one SRS to the terminal.

The delivering of the information on the beam index of the one SRS to the terminal may comprise: delivering, by the source base station, the information on the beam index of the one SRS using at least one of a radio resource control (RRC) message or a medium access control (MAC) control element (CE) of a cell switch command.

The method may further comprise: transmitting, to the terminal, a cell switch command including a unified transmission configuration index (TCI) state configured as a joint UL/DL TCI state identifier.

An early beam management apparatus according to a third exemplary embodiment of the present disclosure, implemented as a terminal, may comprise at least one processor, wherein the at least one processor may cause the terminal to perform: receiving at least one signal from at least one candidate base station; transmitting a first signal strength measurement result for the at least one signal to a source base station; performing early downlink (DL) beam management for one candidate base station selected among the at least one candidate base station based on the first signal strength measurement result; and performing uplink (UL) beam management with the one candidate base station.

In the performing of the early DL beam management for the one candidate base station, the at least one processor may cause the terminal to perform: receiving, from the source base station, channel state information-reference signal (CSI-RS) configuration information of the one candidate base station selected based on the first signal strength measurement result; receiving at least one CSI-RS from the one candidate base station according to the CSI-RS configuration information; measuring a signal strength for the at least one CSI-RS; transmitting a second signal strength measurement result for the at least one CSI-RS to the source base station; and receiving, from the source base station, a beam index of a best CSI-RS selected based on the second signal strength measurement result.

In the performing of the UL beam management with the one candidate base station, the at least one processor may cause the terminal to perform: receiving, from the source base station, a sounding reference signal (SRS) transmission request message including scheduling information and a sequence index for SRS transmission; transmitting at least one SRS to the one candidate base station; and receiving, from the source base station, information on a beam index of one SRS selected among the at least one SRS.

The at least one processor may further cause the terminal to perform: receiving, from the source base station, a cell switch command including a unified transmission configuration index (TCI) state configured as a joint UL/DL TCI state identifier; performing cell switching to the one candidate base station; and transmitting and receiving signals with the one candidate base station using the joint UL/DL TCI state identifier.

According to the present disclosure, in a lower-layer triggered mobility (LTM) procedure, a terminal can perform downlink and uplink beam management procedures with a target cell in advance before performing cell switching. Accordingly, the terminal can omit a beam management procedure after the cell switching and can rapidly receive data from the target cell. Furthermore, the terminal can rapidly transmit data to the target cell. As a result, the terminal can reduce data interruption or quality degradation that may occur during handover.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a sequence chart illustrating exemplary embodiments of a lower-layer triggered mobility method.

FIG. 4 is a conceptual diagram illustrating a payload format of a cell switch command message.

FIG. 5 is a conceptual diagram illustrating exemplary embodiments of intra-CU cell switching.

FIG. 6 is a conceptual diagram illustrating exemplary embodiments of inter-CU cell switching.

FIG. 7 is a sequence chart illustrating exemplary embodiments of an early beam management method in a communication system.

FIG. 8 is a flow chart illustrating an exemplary embodiment of a method for early beam management determination.

FIG. 9 is a sequence chart illustrating exemplary embodiments of a DL beam management method.

FIG. 10 is a sequence chart illustrating exemplary embodiments of a UL beam management method.

FIG. 11 is a sequence chart illustrating exemplary embodiments of a DL and UL beam management method.

FIG. 12 is a sequence chart illustrating exemplary embodiments of a DL and UL beam management method.

FIG. 13 is a conceptual diagram illustrating a payload format of a cell switch command message.

FIG. 14A and FIG. 14B are sequence charts illustrating exemplary embodiments of an early beam management method in a communication system.

FIGS. 15A and 15B are sequence charts illustrating exemplary embodiments of an early beam management method in a communication system.

FIG. 16 is a conceptual diagram illustrating exemplary embodiments of configuration information related to DL and UL channel measurement included in a RRC reconfiguration message.

FIG. 17 is a flowchart illustrating exemplary embodiments of a method for completing cell switching.

FIG. 18 is a flowchart illustrating exemplary embodiments of a method for completing cell switching.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

In the present disclosure, a phrase including “when ˜” may be expressed as a phrase including “based on ˜” or a phrase including “in response to ˜”. In other words, a phrase including “when ˜” may be interpreted as the same as or similar to a phrase including “based on ˜” or a phrase including “in response to ˜”.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments according to the present disclosure will be described with respect to a communication system to which the exemplary embodiments are applied. The communication system to which the exemplary embodiments according to the present disclosure are applied is not limited to the content described below, and the exemplary embodiments according to the present disclosure may be applied to various communication systems. Here, the communication system may be used in the same sense as a communication network.

Throughout the present disclosure, a network may include, for example, wireless Internet such as wireless fidelity (WiFi), portable Internet such as wireless broadband internet (WiBro) or world interoperability for microwave access (WiMax), a 2G mobile communication network such as global system for mobile communication (GSM) or code division multiple access (CDMA), a 3G mobile communication network such as wideband code division multiple access (WCDMA) or CDMA2000, a 3.5G mobile communication network such as high speed downlink packet access (HSDPA) or high speed uplink packet access (HSUPA), a 4G mobile communication network such as long term evolution (LTE) network or LTE-Advanced network, and a 5G mobile communication network.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, a base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

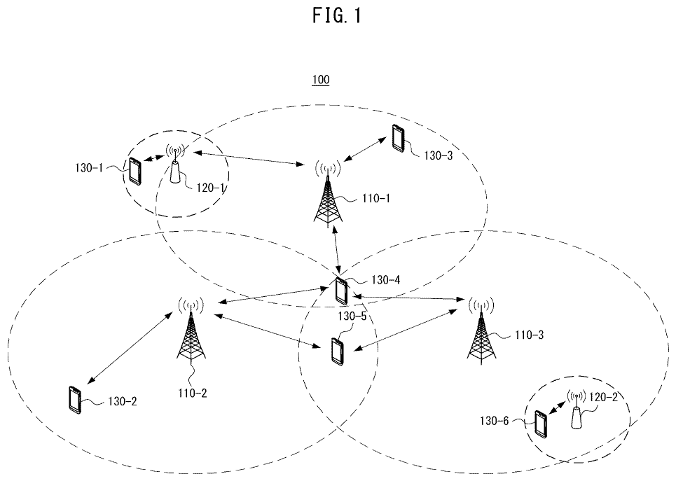

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

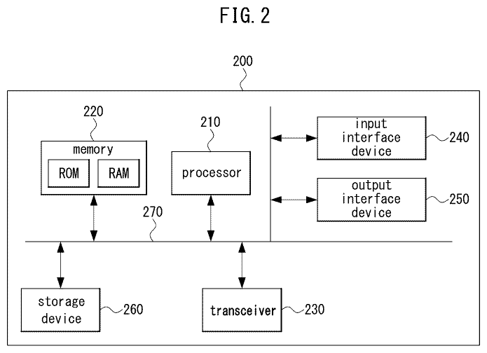

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of user equipments (UEs) 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to the cell coverage of the first base station 110-1. Also, the second UE 130-2, the fourth UE 130-4, and the fifth UE 130-5 may belong to the cell coverage of the second base station 110-2. Also, the fifth base station 120-2, the fourth UE 130-4, the fifth UE 130-5, and the sixth UE 130-6 may belong to the cell coverage of the third base station 110-3. Also, the first UE 130-1 may belong to the cell coverage of the fourth base station 120-1, and the sixth UE 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of UE 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding UE 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of UEs 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, a terminal may move from a serving cell of a source base station to a non-serving cell of a target base station. A communication system may perform a handover procedure, and for example, a layer 3 (L3)-based handover procedure may be performed. In the L3-based handover procedure, the terminal may periodically measure signal qualities of neighbor cells. The terminal may transmit a measurement report message including the measured signal qualities to the source base station. The source base station may receive the measurement report message including the signal qualities measured by the terminal. The source base station may determine a handover based on the received signal qualities.

When the source base station determines a handover for the terminal, the source base station may determine a target base station to which the terminal is to move based on the measurement report message on neighbor cells received from the terminal. The source base station may transmit a handover request message to the target base station. The target base station may receive the handover request message from the source base station. The target base station may perform an admission control procedure for determining whether to accept the handover request. After performing the admission control procedure, the target base station may deliver, to the source base station, a handover response message indicating that the handover is possible.

The source base station may receive, from the target base station, the handover response message indicating that the handover is possible. The source base station may transmit a radio resource control (RRC) reconfiguration message including a handover command to the terminal. The terminal may receive the RRC reconfiguration message and may perform the handover. The RRC reconfiguration message may include information on a physical random access channel (PRACH) preamble index, a PRACH occasion (RO), and a transmission configuration index (TCI) necessary for the terminal to perform the handover.

The source base station may receive data directed to the terminal from a data network. The source base station may not deliver the data received from the data network to the terminal, and may forward the data to the target base station. The target base station may receive the data from the source base station. The target base station may buffer the data. The terminal may successfully complete the handover. The target base station may deliver the buffered data to the terminal. The terminal may receive the data from the target base station.

The terminal may receive the RRC reconfiguration message from the source base station. The terminal may release the connection with the source base station. The terminal may transmit a PRACH preamble to the target base station through a PRACH procedure and may attempt a connection to the target base station. The target base station may not receive the PRACH preamble from the terminal. In this case, the target base station may not be able to transmit a random access channel (RACH) response message to the terminal. The terminal may not receive the RACH response message from the target base station. The terminal may perform a retransmission procedure for retransmitting the PRACH preamble to the target base station.

The handover may require much time. The target base station may store data received from the data network during a handover period. According to completion of the PRACH procedure, the RRC reconfiguration may be completed. The target base station may become a new source base station for the terminal. The terminal may perform packet exchange with the data network via the new source base station.

A path switching procedure may be performed in an upper layer between the source base station and the target base station. According to completion of the path switching procedure, the handover procedure may be completed. In the handover triggered at the upper layer, the terminal may perform the PRACH procedure to connect to the target base station. During performing the PRACH procedure, the terminal may not be connected to the source base station and may experience disconnection from the source base station. Reception quality may decrease in proportion to an interruption time. To solve the deterioration of reception quality, the 3GPP is proceeding with standardization of a lower-layer triggered mobility (LTM) method for performing a handover in a layer 1 or layer 2, not in the layer 3, in release 18 (Rel-18).

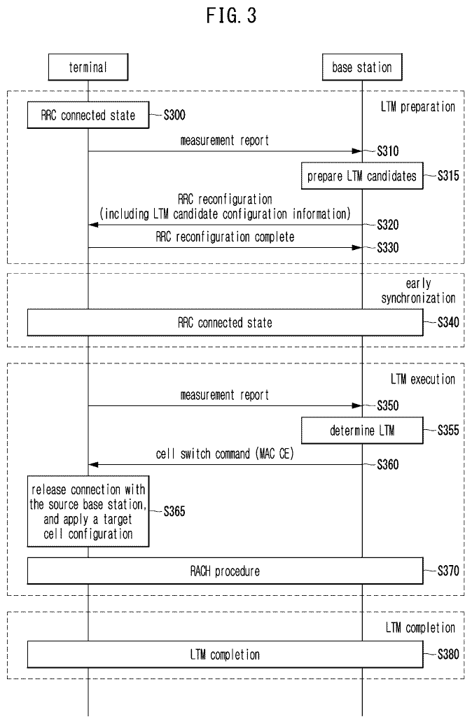

FIG. 3 is a sequence chart illustrating exemplary embodiments of a lower-layer triggered mobility method.

Referring to FIG. 3, an LTM procedure may include an LTM preparation process, an early synchronization process, an LTM execution process, and an LTM completion process. An RRC connection between a base station and a terminal may be assumed as a connected state (i.e. RRC connected state). In the LTM preparation process of the LTM procedure, steps 300 to 330 may be performed. The terminal may be in the RRC connected state with the base station (S300). The terminal may transmit a measurement report message to the base station to report results of signal strength measurements on a serving cell and neighbor cells (S310). The signal strength may be measured as a layer 1-reference signal received power (L1-RSRP).

The base station may prepare LTM candidate cells or candidate beams based on the reported signal strength measurement results (S315). The base station may transmit an RRC reconfiguration message to the terminal to transmit prepared LTM candidate cell configuration information or prepared LTM candidate beam configuration information. The RRC reconfiguration message may include configuration information such as beam indexes and physical cell identity (PCI) values for the respective LTM candidate cells or candidate beams. The terminal may receive the RRC reconfiguration message and may store the LTM candidate cell configuration information or the LTM candidate beam configuration information (S320). The terminal may transmit an RRC reconfiguration complete message to the base station in response to the RRC reconfiguration message (S330).

In the early synchronization process of the LTM procedure, the terminal may acquire downlink (DL) synchronization for LTM candidate cells before receiving an LTM cell switch command message to reduce an interruption time. The terminal may acquire uplink (UL) synchronization (S340). The early synchronization process of the LTM procedure may not be essential in the LTM procedure. However, when the early synchronization process is not performed in the LTM procedure, a RACH procedure may be required for a candidate cell designated by the base station at a stage where an actual cell switching occurs. The RACH procedure may cause delay.

The early synchronization process of the LTM procedure may use a first synchronization method or a second synchronization method. In the first synchronization method, the terminal may receive synchronization signal blocks (SSBs) from the candidate cells and may obtain timing advance (TA) values based on frame synchronization errors with the base station currently synchronized. In the second synchronization method, the base station may transmit a physical downlink control channel (PDCCH) order to the terminal, and the terminal may receive the PDCCH order from the base station and may obtain TA values for the candidate cells by performing RACH procedures for the candidate cells according to the received PDCCH order.

In the first synchronization method, the terminal may not transmit a separate PRACH preamble to each of the candidate cells. In the first synchronization method, the terminal may not directly receive measurement information from the candidate cells and may have large errors. Through the second synchronization method, the terminal may obtain accurate TA values from the candidate cells. In the second synchronization method, the terminal may receive RAR messages from multiple candidate cells. In the second synchronization method, the terminal may consume a very large amount of downlink resources.

In the second synchronization method, the terminal may maintain the connection with the serving cell. In the second synchronization method, RAR messages of the candidate cells may not be directly delivered to the terminal and may be delivered to the terminal via the source base station. In the second synchronization method, the source base station may deliver an RAR message for reconfiguring the connection with the source base station to the terminal. In the second synchronization method, the source base station may deliver the RAR messages received from the candidate cells to the terminal. The RAR message may include a field for distinguishing an RAR message for re-establishing the connection with the source base station and an RAR message received from the candidate cell. Therefore, the RAR message may not reuse an existing RAR message format.

In the LTM execution process of the LTM procedure, steps 350 to 370 may be performed. The terminal may perform signal strength measurement on the LTM candidate cells and may transmit an L1 signal strength measurement result report message to the base station. The base station may receive the L1 signal strength measurement result report message of the terminal (S350). The base station may determine an LTM candidate cell to be changed to a target cell based on the L1 signal strength measurement result of the terminal received in step 350 (S355).

The base station may transmit a cell switch command to the terminal through a medium access control (MAC) control element (CE) (S360). The terminal may release the connection with the source base station and may apply a target cell configuration (S365). The terminal may attempt access by configuring a candidate cell as a target cell. When UL synchronization is invalid, the terminal may perform a RACH procedure to acquire UL synchronization (S370). A TA value included in the cell switch command may be set to an invalid value (e.g. ‘FFF’), and a contention-free random access resource field may not exist in the cell switch command. In this case, the terminal may use a TA value measured by the terminal itself. A TA value may be designated in the cell switch command. In this case, the terminal may use the designated TA value, and the terminal may not perform a RACH procedure for cell switching. A TA value may be designated as an invalid value in the cell switch command, and a contention-free random access resource field may exist. In this case, the terminal may perform a RACH procedure to obtain a TA value for the candidate cell. The cell switching may be successfully completed. In the LTM completion process of the LTM procedure, the terminal may inform the target base station that target cell access has been successfully completed (S380). The base station may start data transmission to the terminal.

Compared with the L3-triggered handover procedure, the LTM method may perform cell switching using the cell switch command MAC CE, which is a layer 2 generated message. The LTM method may perform cell switching faster than the handover through L3 RRC messages. In other words, in the LTM method, handover determination and execution may be performed in the layer 2. Therefore, faster cell switching may be possible in the LTM method compared with the method in which handover determination and execution are performed in the layer 3.

In the LTM method, the terminal may acquire TA values for candidate cells before cell switching through the early synchronization process and may perform fast cell switching. The terminal may transmit RACHs to the candidate cells to acquire TA values for multiple candidate cells in the early synchronization process. In the early synchronization process, the terminal may extract TA values from SSBs received from the candidate cells, and may store and maintain the extracted TA values. In the early synchronization process, an overhead of the terminal may increase due to the process of extracting the TA values and storing and maintaining the TA values. Power consumption of the terminal may also be large. In the early synchronization process, the base station may transmit control signals to the terminal. Due to these signals, the base station may waste a large amount of radio resources. The cell switch command message may be delivered to the terminal in the form of a MAC CE. The MAC CE of the cell switch command message may be identified by a MAC subheader including an extended logical channel ID (eLCID).

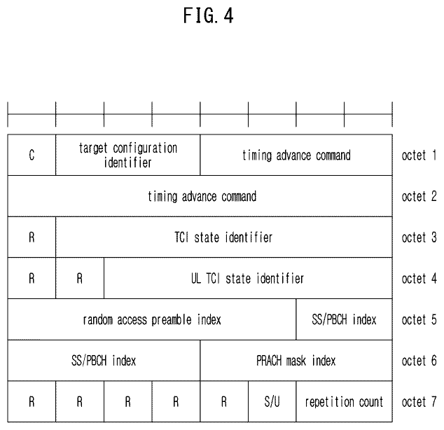

FIG. 4 is a conceptual diagram illustrating a payload format of a cell switch command message.

Referring to FIG. 4, a payload of a cell switch command message may include at least one of a contention-free random access resource (C) field, a target configuration identifier field, a timing advance command field, a TCI state identifier field, a UL TCI state identifier field, a reserved (R) field, a random access preamble index field, a synchronization signal/physical broadcast channel (SS/PBCH) field, a PRACH mask index field, an S/U field, or a repetition count field. Each field may be defined as follows.
Reserved field: The reserved field may be a field indicating reserved bits. The reserved field may be set to 0.
Target configuration identifier field: The target configuration identifier field may be a field indicating an index of a candidate target configuration to be applied to LTM cell switching. The length of the target configuration identifier field may be 3 bits.
Timing advance command field: The timing advance command field may be a field indicating whether TA for the LTM target cell is valid. When a value of the timing advance command field is ‘FFF’, it may mean that no valid timing adjustment exists, and otherwise, it may indicate an index value of timing adjustment to be applied. The length of the timing advance command field may be 12 bits.
TCI state identifier field: The TCI state identifier field may be a field indicating a TCI state of the LTM target cell. The length of the TCI state identifier field may be 7 bits.
UL TCI state identifier field: The UL TCI state identifier field may be a field indicating a UL TCI state of the LTM target cell. The length of the UL TCI state identifier field may be 6 bits.
Contention-free random access resource field: The contention-free random access resource field may be a field indicating presence of a contention-free random access resource. When the value is 1, the resource may exist, and when the value is 0, the resource may not exist.
S/U field: The S/U field may be a 1-bit field indicating a UL carrier used for PRACH transmission in a non-contention-free manner. When the value of the field is 1, a supplementary uplink (SUL) carrier may be used, and when the value is 0, a normal uplink (NUL) carrier may be used. The length of the S/U field may be 1 bit.
Random access preamble index field: The random access preamble index field may be a field indicating a random access preamble index of a contention-free random access resource. The length of the random access preamble index field may be 6 bits.
SS/PBCH index field: The SS/PBCH field may be a field indicating an SS/PBCH block for determining a RACH occasion for PRACH transmission. The length of the SS/PBCH field may be 6 bits.
PRACH mask index field: The PRACH mask index field may be a field indicating a RACH occasion associated with the SS/PBCH block for PRACH transmission. When the repetition count field is not 0, the PRACH mask index field may be ignored. The PRACH mask index field may be used only for contention-free PRACH transmission. This may be because when the repetition count field is not 0, it corresponds to contention-based PRACH transmission. The length of the PRACH mask index field may be 4 bits.
Repetition count field: The repetition count field may be a field indicating a repetition count of message 1 (e.g. Msg1) to be applied to contention-free random access. When the value of the repetition count field is 0, the repetition count of Msg1 may not be applied. When the value of the repetition count field is 1, the repetition count may be 2, when the value is 2, the repetition count may be 4, and when the value is 3, the repetition count may be 8. The length of the repetition count field may be 2 bits.

In the LTM method introduced in release 18, the terminal may receive a cell switch command from the base station. The terminal may release the connection with the source base station and may perform a procedure for connecting with a target cell by applying a target cell configuration. The terminal may be connected to the target cell through DL and UL beam management procedures. The terminal that acquires early synchronization may also require DL and UL beam management procedures to be connected to the target cell. As described above, the terminal may require beam management procedures for transmitting and receiving data with the target cell, and may require a certain time to perform the beam management procedures. In other words, the terminal may require a certain time to perform the beam management procedures when receiving data stored in the target cell, and may require a certain time to perform the beam management procedures for transmitting data stored in the terminal to the target cell.

The LTM method introduced in release 18 may not include a separate beam management procedure for connection with the target cell. Therefore, the LTM method introduced in release 18 may not reduce the time required to perform the beam management procedure after cell switching. Furthermore, a time required for data transfer between central units (CUs) in inter-CU cell switching may be longer than a time required for data transfer between CUs in intra-CU cell switching. Therefore, in inter-CU cell switching, even when the terminal already knows the TA value and does not perform the PRACH procedure, the terminal may require rapid data connection. Accordingly, the LTM method may need to perform DL and UL beam management procedures for the target cell before cell switching. The present disclosure provides methods and procedures for solving such problems of the LTM method introduced in release 18.

The present disclosure is directed to providing methods and apparatuses that extend the LTM method that performs a rapid cell switching procedure in layer 1 and layer 2 to an inter-CU scenario and allow rapid data exchange in order to support rapid mobility of a terminal in a mobile communication system.

In the LTM method introduced in release 18, after the terminal receives a cell switch command MAC CE from a serving cell, the terminal may not be connected with the serving cell for a certain time (i.e. interruption time). The present disclosure provides methods and procedures for performing DL and UL beam management in advance before the terminal and the serving cell are disconnected in order to minimize the interruption time. While the terminal and the serving cell are not connected, in other words, during a time for performing the procedure for cell switching, the target cell may store data directed to the terminal. Furthermore, a time required for data transfer between CUs in inter-CU cell switching may be longer than a time required for data transfer between CUs in intra-CU cell switching. Therefore, in inter-CU cell switching, even when the terminal already knows the TA value in advance and does not perform the PRACH procedure, the terminal may require rapid data connection.

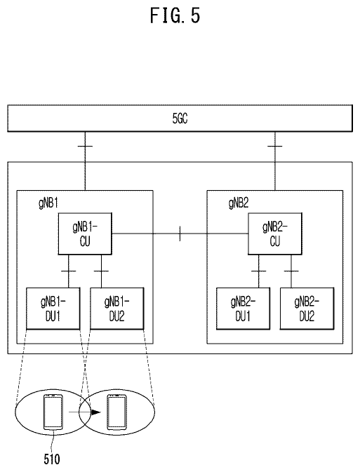

FIG. 5 is a conceptual diagram illustrating exemplary embodiments of intra-CU cell switching.

Referring to FIG. 5, a communication system may include a 5G core network (5GC), a first base station (gNB1), and a second base station (gNB2). The first base station may include a CU of the first base station (gNB1-CU), a first distributed unit (DU) of the first base station (gNB1-DU1), and a second DU of the first base station (gNB1-DU2). The second base station may include a CU of the second base station (gNB2-CU), a first DU of the second base station (gNB2-DU1), and a second DU of the second base station (gNB2-DU2).

A terminal 510 may be present within a serving cell of the first DU of the first base station. The terminal 510 may be present outside a non-serving cell of the second DU of the first base station. The first DU of the first base station and the second DU of the first base station may be connected to the same CU of the first base station. The terminal may move from the serving cell to the non-serving cell. The terminal may move between DUs connected to the same CU of the same base station (gNB1), and may perform relatively rapid cell switching.

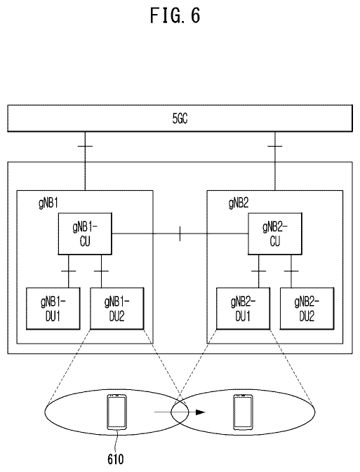

FIG. 6 is a conceptual diagram illustrating exemplary embodiments of inter-CU cell switching.

Referring to FIG. 6, a communication system may include a 5G core network, a first base station (gNB1), and a second base station (gNB2). The first base station may include a CU of the first base station (gNB1-CU), a first DU of the first base station (gNB1-DU1), and a second DU of the first base station (gNB1-DU2). The second base station may include a CU of the second base station (gNB2-CU), a first DU of the second base station (gNB2-DU1), and a second DU of the second base station (gNB2-DU2).

A terminal 610 may be present within a serving cell of the second DU of the first base station. The terminal 610 may be present outside a non-serving cell of the first DU of the second base station. The first DU of the first base station and the second DU of the first base station may be connected to the same CU of the first base station. The first DU of the second base station and the second DU of the second base station may be connected to the same CU of the second base station. The terminal may move from the serving cell to the non-serving cell.

The inter-CU cell switching may have complicated procedures because switching between different CUs is performed. For example, to switch to a target cell, a source DU may make a switching request to a source CU through an F1 interface. The source CU may receive the switching request from the source DU. The source CU may transmit a switching request to a target CU through an Xn-C interface. The target CU may receive the switching request from the source CU. The target CU may transmit a switching request to a target DU. The target DU may receive the switching request from the target CU. A time required for data transfer between CUs in inter-CU cell switching may be longer than a time required for data transfer between CUs in intra-CU cell switching. Accordingly, the terminal may perform DL and UL beam management procedures with the target cell in advance before performing cell switching by receiving a cell switch command MAC CE. The terminal may receive data from the target cell quickly by performing DL and UL beam management procedures in advance. The terminal may transmit data to the target cell quickly by performing DL and UL beam management procedures at an early time. The terminal may also be able to transmit and receive data simultaneously with signaling procedures in an upper layer between CUs.

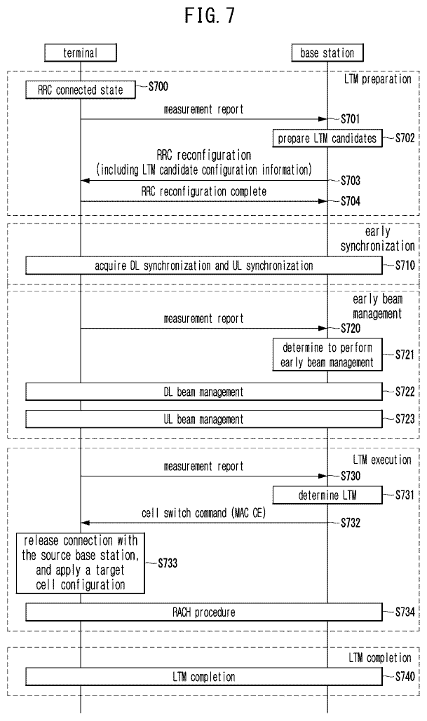

FIG. 7 is a sequence chart illustrating exemplary embodiments of an early beam management method in a communication system.

Referring to FIG. 7, an LTM procedure may include an LTM preparation process, an early synchronization process, an early beam management process, an LTM execution process, and an LTM completion process. An RRC connection between a base station and a terminal may be assumed to be in a connected state. In the LTM preparation process of the LTM procedure, the terminal may be in the RRC connected state with the base station (S700). The terminal may transmit a measurement report message to the base station to report results of signal strength measurements on a serving cell and neighbor cells (S701). The signal strength may be measured as L1-RSRP.

The base station may prepare LTM candidate cells or candidate beams based on the reported signal strength measurement results (S702). The base station may transmit an RRC reconfiguration message to the terminal to transmit prepared LTM candidate cell configuration information or prepared LTM candidate beam configuration information. The RRC reconfiguration message may include configuration information such as beam indexes and physical cell identity values for the respective LTM candidate cells or candidate beams. The terminal may receive the RRC reconfiguration message and may store the LTM candidate cell configuration information or the LTM candidate beam configuration information (S703). The terminal may transmit an RRC reconfiguration complete message to the base station in response to the RRC reconfiguration message (S704).

In the early synchronization process of the LTM procedure, the terminal may acquire DL synchronization for LTM candidate cells before receiving an LTM cell switch command message to reduce an interruption time. The terminal may acquire UL synchronization (S710). The early synchronization process of the LTM procedure may not be essential in the LTM procedure. However, when the early synchronization process is not performed in the LTM procedure, a RACH procedure may be required for a candidate cell designated by the base station at a stage where an actual cell switching occurs. The RACH procedure may cause delay.

The early synchronization process of the LTM procedure may use a first synchronization method or a second synchronization method. In the first synchronization method, the terminal may receive synchronization signal blocks (SSBs) from the candidate cells and may obtain timing advance (TA) values based on frame synchronization errors with the base station currently synchronized. In the second synchronization method, the base station may transmit a physical downlink control channel (PDCCH) order to the terminal, and the terminal may receive the PDCCH order from the base station and may obtain TA values for the candidate cells by performing RACH procedures for the candidate cells according to the received PDCCH order.

In the first synchronization method, the terminal may not transmit a separate PRACH preamble to each of the candidate cells. In the first synchronization method, the terminal may not directly receive measurement information from the candidate cells and may have large errors. Through the second synchronization method, the terminal may obtain accurate TA values from the candidate cells. In the second synchronization method, the terminal may receive RAR messages from multiple candidate cells. In the second synchronization method, the terminal may consume a very large amount of downlink resources.

In the second synchronization method, the terminal may maintain the connection with the serving cell. In the second synchronization method, RAR messages of the candidate cells may not be directly delivered to the terminal and may be delivered to the terminal via the source RAR message for reconfiguring the connection with the source base station to the terminal. In the second synchronization method, the source base station may deliver the RAR messages received from the candidate cells to the terminal. The RAR message may include a field for distinguishing an RAR message for re-establishing the connection with the source base station and an RAR message received from the candidate cell. Therefore, the RAR message may not reuse an existing RAR message format.

In the early beam management process, the terminal may transmit an L1 measurement report message of signal strength measurement results of the serving cell and the candidate cells to the source base station (S720). The source base station may receive the L1 measurement report message from the terminal. The source base station may determine to perform early beam management based on the L1 measurement report message received from the terminal (S721). The terminal, the source base station, and a target base station may perform DL beam management (S722). The terminal, the source base station, and the target base station may perform UL beam management (S723).

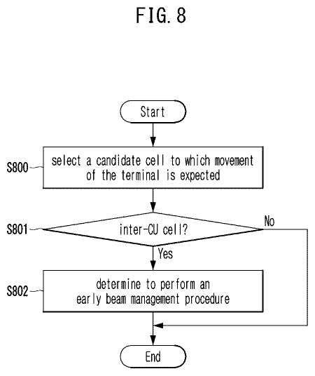

FIG. 8 is a flow chart illustrating an exemplary embodiment of a method for early beam management determination.

Referring to FIG. 8, a source base station may select a candidate cell to which movement of a terminal is expected among candidate cells based on an L1 measurement report message received from the terminal (S800). The source base station may determine whether the selected candidate cell is an inter-CU cell (S801). The source base station may determine to perform an early beam management procedure when the selected candidate cell is an inter-CU cell (S802). The source base station may determine to perform DL beam management by considering at least one of a movement speed, a DL traffic amount, or a UL traffic amount of the terminal. The source base station may determine to perform UL beam management by considering at least one of the movement speed, the DL traffic amount, or the UL traffic amount of the terminal. The source base station may determine to perform DL beam management and UL beam management by considering at least one of the movement speed, the DL traffic amount, or the UL traffic amount of the terminal. For example, the movement speed of the terminal may be high, and the DL traffic may be dominant. In such a case, the source base station may determine not to perform UL beam management. The source base station may save time and resources for performing UL beam management by not performing UL beam management.

Referring again to FIG. 7, in the LTM procedure execution process of the LTM procedure, the terminal may perform signal strength measurement for LTM candidate cells and may transmit an L1 signal strength measurement result report message to the base station. The base station may receive the L1 signal strength measurement result report message from the terminal (S730). The base station may determine an LTM candidate cell to be changed to a target cell based on the received L1 signal strength measurement result of the terminal (S731).

The base station may transmit a cell switch command to the terminal through a MAC CE (S732). The terminal may release the connection with the source base station and may apply a target cell configuration (S733). The terminal may attempt access by configuring the candidate cell as the target cell. When UL synchronization is invalid, the terminal may perform a RACH procedure to acquire UL synchronization (S734). A TA value included in the cell switch command may be an invalid value (e.g. ‘FFF’), and a non-contention-based random access resource field may not exist in the cell switch command. In this case, the terminal may use a TA value measured by the terminal itself. A TA value may be designated in the cell switch command. In this case, the terminal may use the designated TA value, and may not perform a RACH procedure for cell switching. The TA value in the cell switch command may be designated as an invalid value, and a non-contention-based random access resource field may exist. In this case, the terminal may perform a RACH procedure to acquire a TA value for the candidate cell. The cell switching may be successfully completed. In the LTM completion process of the LTM procedure, the terminal may notify the target base station that the target cell access has been normally completed (S740). The base station may start data transmission to the terminal.

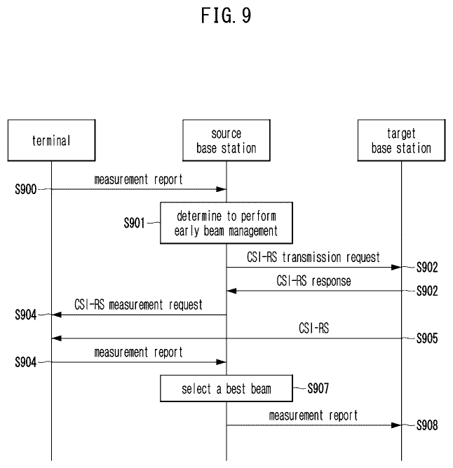

FIG. 9 is a sequence chart illustrating exemplary embodiments of a DL beam management method.

Referring to FIG. 9, in the early beam management process, the terminal may transmit an L1 measurement report message including signal strength measurement results of the serving cell and the candidate cell to the source base station (S900). The source base station may receive the L1 measurement report message from the terminal. The source base station may determine to perform early beam management based on the L1 measurement report message received from the terminal (S901). The source base station may transmit a channel state information-reference signal (CSI-RS) transmission request message to the target base station for DL beam management (S902). The CSI-RS transmission request message may include at least one of information on a beam index of a beam for SSB transmission of the target cell or information on a TCI state identifier of the beam, which is acquired in the early synchronization process.

The target base station may receive the CSI-RS transmission request message from the source base station. When the target base station accepts the CSI-RS transmission request, the target base station may transmit a CSI-RS response message to the source base station (S903). The source base station may receive the CSI-RS response message from the target base station. The CSI-RS response message may include at least one of scheduling information or a scrambling identifier for CSI-RS reception.

The source base station may transmit a CSI-RS measurement request message to the terminal (S904). The CSI-RS measurement request message may include at least one of the scheduling information or the scrambling identifier for CSI-RS measurement. The terminal may receive the CSI-RS measurement request message including at least one of the scheduling information and the scrambling identifier for CSI-RS measurement from the source base station.

The target base station may select beams for CSI-RS transmission corresponding to the beam index or the TCI state identifier of the beam for SSB transmission received from the source base station, and may transmit CSI-RSs to the terminal using the selected beams (S905). The beam for SSB transmission may have a wide beam width. The beams for CSI-RS transmission may have a narrow beam width. A plurality of beams for CSI-RS transmission may be included in one beam for SSB transmission.

The terminal may receive CSI-RSs through the beams from the target base station. The terminal may measure signal quality for each of the received CSI-RSs. The terminal may acquire information on a beam index and a TCI state identifier for each of the beams used for CSI-RS transmission. The terminal may transmit a measurement report message including at least one of information on the signal quality for each of the CSI-RSs, information on the beam index for each of the CSI-RSs, or information on the TCI state identifier for each of the CSI-RSs to the source base station (S906). The source base station may receive the measurement report message including at least one of information on the signal quality for each of the CSI-RSs, information on the beam index for each of the CSI-RSs, or information on the TCI state identifier for each of the CSI-RSs from the terminal. The source base station may select a best beam based on the signal quality for each of the received CSI-RSs (S907). The source base station may transmit a measurement report message including at least one of information on a beam index or a TCI state identifier of the selected best beam to the target base station (S908). The target base station may receive the measurement report message including at least one of information on the beam index or the TCI state identifier of the best beam from the source base station. Thereafter, the source base station may transmit a cell switch command to the terminal through a MAC CE. The terminal may release the connection with the source base station and may apply a target cell configuration. The terminal may attempt access by configuring the candidate cell as the target cell. The target base station may select a DL beam based on information on the beam index or the TCI state identifier of the best beam, and may deliver data to the terminal through the selected DL beam. The terminal may receive data from the target base station through the DL beam.

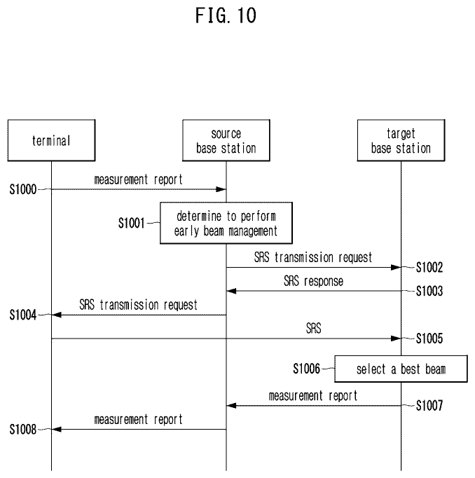

FIG. 10 is a sequence chart illustrating exemplary embodiments of a UL beam management method.

Referring to FIG. 10, in the early beam management process, the terminal may transmit an L1 measurement report message including signal strength measurement results of the serving cell and the candidate cell to the source base station (S1000). The source base station may receive the L1 measurement report message from the terminal. The source base station may determine to perform early beam management based on the L1 measurement report message received from the terminal (S1001). The source base station may transmit a sounding reference signal (SRS) transmission request message to the target base station for UL beam management (S1002). The SRS transmission request message may include at least one of information on a beam index of a beam for SSB transmission of the target cell or information on a TCI state identifier of the beam, which is acquired in the early synchronization process.

The target base station may receive the SRS transmission request message from the source base station. When the target base station accepts the SRS transmission request, the target base station may transmit an SRS response message to the source base station (S1003). The source base station may receive the SRS response message from the target base station. The SRS response message may include at least one of scheduling information or a sequence index for SRS transmission. The source base station may transmit an SRS transmission request message to the terminal (S1004). The SRS transmission request message may include at least one of the scheduling information or the sequence index for SRS transmission. The terminal may receive the SRS transmission request message including at least one of the scheduling information or the sequence index for SRS transmission from the source base station.

The terminal may select beams for SRS transmission corresponding to the beam index of the SSB of the target base station and the TCI state identifier of the target base station, and may transmit SRSs to the target base station using the selected beams according to at least one of the scheduling information or the sequence index for SRS transmission received from the source base station (S1005). The beam SSB transmission may have a wide beam width. The beams for SRS transmission may have a narrow beam width. A plurality of beams for SRS transmission may be included in one beam for SSB transmission.

The target base station may receive the SRSs through the beams from the terminal. The target base station may measure signal quality for each of the received SRSs. The target base station may acquire information on a beam index and a TCI state identifier for each of the beams used for SRS transmission. The target base station may select a best beam based on the signal quality for each of the received SRSs (S1006). The target base station may transmit a measurement report message including at least one of information on a beam index or a TCI state identifier of the selected best beam to the source base station (S1007). The source base station may receive the measurement report message including at least one of information on the beam index or the TCI state identifier of the best beam from the target base station.

The source base station may transmit a measurement report message including at least one of information on the beam index of the best beam or information on the TCI state identifier of the best beam to the terminal (S1008). The terminal may receive the measurement report message including at least one of the information on the beam index of the best beam or the information on the TCI state identifier of the best beam from the source base station. The source base station may deliver the measurement report to the terminal as an RRC message. The source base station may deliver the measurement report by including the measurement report in a cell switch MAC CE after termination of the early beam management procedure.

Thereafter, the source base station may transmit a cell switch command to the terminal through a MAC CE. The terminal may release the connection with the source base station and may apply a target cell configuration. The terminal may attempt access by configuring the candidate cell as the target cell. The terminal may select a UL beam based on information on the beam index of the best beam or information on the TCI state identifier of the best beam, and may transmit data to the target base station using the selected UL beam. The target base station may receive data from the terminal through the UL beam.

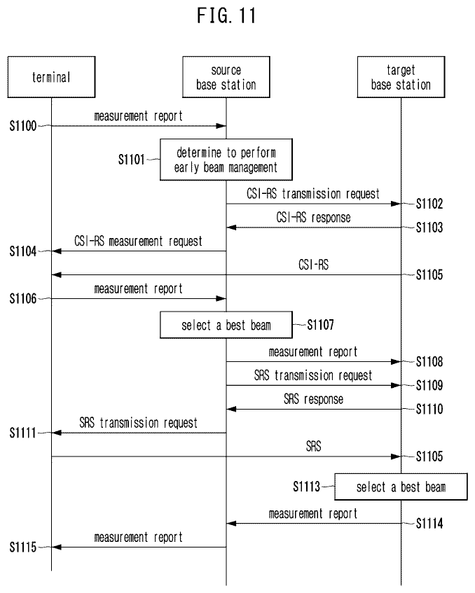

FIG. 11 is a sequence chart illustrating exemplary embodiments of a DL and UL beam management method.

Referring to FIG. 11, in the early beam management process, the terminal may transmit an L1 measurement report message including signal strength measurement results of the serving cell and the candidate cell to the source base station (S1100). The source base station may receive the L1 measurement report message from the terminal. The source base station may determine to perform early beam management based on the L1 measurement report message received from the terminal (S1101). The source base station may transmit a CSI-RS transmission request message to the target base station for DL beam management (S1102). The CSI-RS transmission request message may include at least one of information on a beam index of a beam for SSB transmission of the target cell or information on a TCI state identifier of the beam, which is acquired in the early synchronization process.

The target base station may receive the CSI-RS transmission request message from the source base station. When the target base station accepts the CSI-RS transmission request, the target base station may transmit a CSI-RS response message to the source base station (S1103). The source base station may receive the CSI-RS response message from the target base station. The CSI-RS response message may include at least one of scheduling information or a scrambling identifier for CSI-RS reception.

The source base station may transmit a CSI-RS measurement request message to the terminal (S1104). The CSI-RS measurement request message may include at least one of the scheduling information or the scrambling identifier for CSI-RS measurement. The terminal may receive the CSI-RS measurement request message including at least one of the scheduling information or the scrambling identifier for CSI-RS measurement from the source base station.

The target base station may select beams for CSI-RS transmission corresponding to at least one of the beam index or the TCI state identifier of the beam for SSB transmission received from the source base station, and may transmit CSI-RSs to the terminal using the selected beams (S1105). The beam for SSB transmission may have a wide beam width. The beams for CSI-RS transmission may have a narrow beam width. A plurality of beams for CSI-RS transmission may be included in one beam for SSB transmission.

The terminal may receive CSI-RSs through the beams from the target base station. The terminal may measure signal quality for each of the received CSI-RSs. The terminal may acquire information on a beam index and a TCI state identifier for each of the beams used for CSI-RS transmission. The terminal may transmit a measurement report message including at least one of information on the signal quality for each of the CSI-RSs, information on the beam index of each of the CSI-RSs, or information on the TCI state identifier of each of the CSI-RSs to the source base station (S1106). The source base station may receive the measurement report message including at least one of the information on the signal quality for each of the CSI-RSs, the information on the beam index of each of the CSI-RSs, or the information on the TCI state identifier of each of the CSI-RSs from the terminal. The source base station may select a best beam based on the signal quality for each of the received CSI-RSs (S1107). The source base station may transmit a measurement report message including at least one of information on a beam index of the selected best beam or information on a TCI state identifier of the selected best beam to the target base station (S1108). The target base station may receive the measurement report message including at least one of the information on the beam index of the best beam or the information on the TCI state identifier of the best beam from the source base station.

The source base station may transmit an SRS transmission request message to the target base station for UL beam management (S1109). The SRS transmission request message may include at least one of information on a beam index of a beam for SSB transmission of the target cell or information on a TCI state identifier of the beam, which is acquired in the early synchronization process. The target base station may receive the SRS transmission request message from the source base station. When the target base station accepts the SRS transmission request, the target base station may transmit an SRS response message to the source base station (S1110). The source base station may receive the SRS response message from the target base station. The SRS response message may include at least one of scheduling information or a sequence index for SRS transmission. The source base station may transmit an SRS transmission request message to the terminal (S1111). The SRS transmission request message may include at least one of the scheduling information or the sequence index for SRS transmission. The terminal may receive the SRS transmission request message including at least one of the scheduling information or the sequence index for SRS transmission from the source base station.

The terminal may select beams for SRS transmission corresponding to at least one of the beam index of the SSB of the target base station or the TCI state identifier of the target base station, and may transmit SRSs to the target base station using the selected beams according to at least one of the scheduling information or the sequence index for SRS transmission received from the source base station (S1112). The beam for SSB transmission may have a wide beam width. The beams for SRS transmission may have a narrow beam width. A plurality of beams for SRS transmission may be included in one beam for SSB transmission.

The target base station may receive SRSs through the beams from the terminal. The target base station may measure signal quality for each of the received SRSs. The target base station may acquire information on a beam index and a TCI state identifier for each of the beams used for SRS transmission. The target base station may select a best beam based on the signal quality for each of the received SRSs (S1113). The target base station may transmit a measurement report message including at least one of information on a beam index of the selected best beam or information on a TCI state identifier of the selected best beam to the source base station (S1114). The source base station may receive the measurement report message including at least one of the information on the beam index of the best beam or the information on the TCI state identifier of the best beam from the target base station.

The source base station may transmit a measurement report message including at least one of information on the beam index of the selected best beam or information on the TCI state identifier of the selected best beam to the terminal (S1115). The terminal may receive the measurement report message including at least one of the information on the beam index of the best beam or the information on the TCI state identifier of the best beam from the source base station. The source base station may deliver the measurement report to the terminal as an RRC message. The source base station may deliver the measurement report by including the measurement report in a cell switch MAC CE after termination of the early beam management process.

Thereafter, the source base station may transmit a cell switch command to the terminal through a MAC CE. The terminal may release a connection with the source base station and may apply a target cell configuration. The terminal may attempt access by configuring the candidate cell as the target cell. The target base station may select a DL beam based on information on the beam index of the best beam or information on the TCI state identifier of the best beam, and may deliver data to the terminal using the selected DL beam. The terminal may receive the data from the target base station through the DL beam. The terminal may select a UL beam based on information on the beam index of the best beam or information on the TCI state identifier of the best beam, and may transmit data to the target base station using the selected UL beam. The target base station may receive the data from the terminal through the UL beam.

The terminal may transmit SRS to the target cell in uplink. When a reception timing difference exists between the serving cell and the target cell, the target cell base station may fail to receive SRS from the terminal. The reception timing difference between the serving cell and the target cell may occur due to different frame timings of the serving cell and the target cell. To solve such a problem, the serving cell may notify the terminal in advance of information on a reception timing error with the target cell so that the terminal reflects the reception timing error when transmitting SRS.

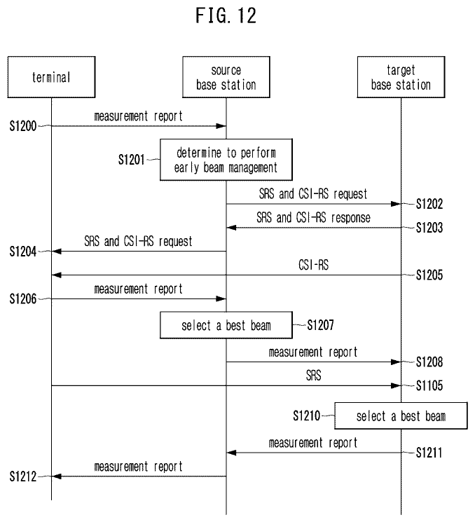

FIG. 12 is a sequence chart illustrating exemplary embodiments of a DL and UL beam management method.

Referring to FIG. 12, in the early beam management process, the terminal may transmit an L1 measurement report message including signal strength measurement results of the serving cell and the candidate cell to the source base station (S1200). The source base station may receive the L1 measurement report message from the terminal. The source base station may determine to perform early beam management based on the L1 measurement report message received from the terminal (S1201). The source base station may transmit an SRS and CSI-RS request message including a CSI-RS transmission request for DL beam management and an SRS transmission request for UL beam management to the target base station (S1202). The SRS and CSI-RS request message may include at least one of information on a beam index of a beam for SSB transmission of the target cell or information on a TCI state identifier of the beam, which is acquired in the early synchronization process.

The target base station may receive the SRS and CSI-RS request message from the source base station. When the target base station accepts the SRS and CSI-RS transmission request, the target base station may transmit an SRS and CSI-RS response message to the source base station (S1203). The source base station may receive the SRS and CSI-RS response message from the target base station. The SRS and CSI-RS response message may include at least one of scheduling information for CSI-RS reception, a scrambling identifier for CSI-RS reception, scheduling information for SRS transmission, or a sequence index for SRS transmission.

The source base station may transmit an SRS and CSI-RS measurement request message including an SRS transmission request and a CSI-RS measurement request to the terminal (S1204). The SRS and CSI-RS measurement request message may include at least one of the scheduling information for CSI-RS measurement, the scrambling identifier for CSI-RS measurement, scheduling information for SRS transmission, or a sequence index for SRS transmission. The terminal may receive the SRS and CSI-RS measurement request message including at least one of the scheduling information for CSI-RS measurement, the scrambling identifier for CSI-RS measurement, the scheduling information for SRS transmission, or the sequence index for SRS transmission from the source base station.

The target base station may select beams for CSI-RS transmission corresponding to at least one of the beam index or the TCI state identifier of the beam for SSB transmission received from the source base station, and may transmit CSI-RS to the terminal using the selected beams (S1205). The beam for SSB transmission may have a wide beam width. The beams for CSI-RS transmission may have a narrow beam width. A plurality of beams for CSI-RS transmission may be included in one beam for SSB transmission.

The terminal may receive CSI-RSs through the beams from the target base station. The terminal may measure signal quality for each of the received CSI-RSs. The terminal may acquire information on a beam index and a TCI state identifier for each of the beams used for CSI-RS transmission. The terminal may transmit a measurement report message including at least one of information on the signal quality for each of the CSI-RSs, information on the beam index of each of the CSI-RSs, or information on the TCI state identifier of each of the CSI-RSs to the source base station (S1206). The source base station may receive the measurement report message including at least one of the information on the signal quality for each of the CSI-RSs, the information on the beam index of each of the CSI-RSs, or the information on the TCI state identifier of each of the CSI-RSs from the terminal. The source base station may select a best beam based on the signal quality for each of the received CSI-RSs (S1207). The source base station may transmit a measurement report message including at least one of information on a beam index of the selected best beam or information on a TCI state identifier of the selected best beam to the target base station (S1208). The target base station may receive the measurement report message including at least one of the information on the beam index of the best beam or the information on the TCI state identifier of the best beam from the source base station.

The terminal may select beams for SRS transmission corresponding to the beam index of the SSB of the target base station or the TCI state identifier of the target base station, and may transmit SRS to the target base station using the selected beams according to at least one of the scheduling information or the sequence index for SRS transmission received from the source base station (S1209). The beam for SSB transmission may have a wide beam width. The beams for SRS transmission may have a narrow beam width. A plurality of beams for SRS transmission may be included in one beam for SSB transmission.

The target base station may receive SRSs through the beams from the terminal. The target base station may measure signal quality for each of the received SRSs. The target base station may acquire information on a beam index and a TCI state identifier for each of the beams used for SRS transmission. The target base station may select a best beam based on the signal quality for each of the received SRSs (S1210). The target base station may transmit a measurement report message including at least one of information on a beam index of the selected best beam or information on a TCI state identifier of the selected best beam to the source base station (S1211). The source base station may receive the measurement report message including at least one of the information on the beam index of the best beam or the information on the TCI state identifier of the best beam from the target base station.

The source base station may transmit a measurement report message including at least one of information on the beam index of the selected best beam or information on the TCI state identifier of the selected best beam to the terminal (S1212). The terminal may receive the measurement report message including at least one of the information on the beam index of the best beam or the information on the TCI state identifier of the best beam from the source base station. The source base station may deliver the measurement report to the terminal as an RRC message. The source base station may deliver the measurement report by including the measurement report in a cell switch MAC CE after termination of the early beam management process.

Thereafter, the source base station may transmit a cell switch command to the terminal through a MAC CE. The terminal may release the connection with the source base station and may apply a target cell configuration. The terminal may attempt access by configuring the candidate cell as the target cell. The target base station may select a DL beam based on information on the beam index of the best beam or information on the TCI state identifier of the best beam, and may deliver data to the terminal using the selected DL beam. The terminal may receive the data from the target base station through the DL beam. The terminal may select a UL beam based on information on the beam index of the best beam or information on the TCI state identifier of the best beam, and may transmit data to the target base station using the selected UL beam. The target base station may receive the data from the terminal through the UL beam.

FIG. 11 illustrates a method of sequentially performing a DL beam management procedure and a UL beam management procedure. FIG. 12 illustrates a method of transmitting a request for DL beam management and UL beam management in a single request message to reduce radio resources and latency. The early beam management procedure may be mainly used in inter-CU cell switching. Transmitting a request message from the source base station to the target base station may require message delivery between CUs.

The inter-CU cell switching may have greater latency compared to intra-CU cell switching. Therefore, reducing the number of message deliveries between CUs may be effective in reducing a time required for early beam management. The early beam management procedure may be more effective when the procedure is performed closer to a time at which a cell switch command is delivered.

This may be because when the early beam management procedure is performed too early, the corresponding result may not be valid at the time of the cell switching. The pre-selected best beam for CSI-RS transmission in downlink may not remain the best beam after cell switching. In such a case, the terminal may perform the early beam management procedure. Otherwise, the terminal may not receive service in a best quality data download environment. FIG. 12 corresponds to an example of performing DL beam management first. Alternatively, in the early beam management method, UL beam management may be performed first.

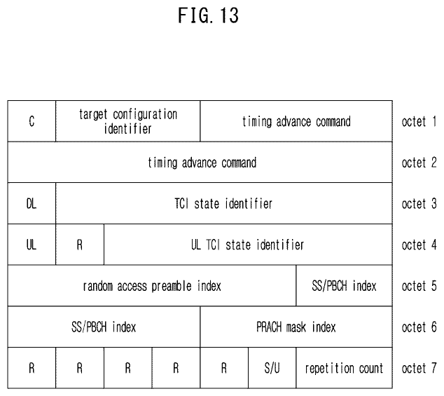

FIG. 13 is a conceptual diagram illustrating a payload format of a cell switch command message.

Referring to FIG. 13, a payload of a cell switch command message may include at least one of a non-contention-based random access resource (C) field, a target configuration identifier field, a timing advance command field, a DL field, a TCI state identifier field, a UL field, a UL TCI state identifier field, a reserved field, a random access preamble index field, an SS/PBCH field, a PRACH mask index field, an S/U field, or a repetition count field. The payload format of the cell switch command message of FIG. 13 may be formed by adding the DL field and the UL field to include a DL beam and a UL beam to the payload format of the cell switch command message of FIG. 4.

The DL field and the UL field may be fields representing indication information with 1 bit, respectively. When the DL field is indicated with a first value (e.g. 1), the TCI state identifier field following the DL field may indicate a beam index or a TCI state identifier of a beam for CSI-RS transmission of a target base station determined in an early beam management process. When the UL field is indicated with a first value (e.g. 1), the UL TCI state identifier field following the UL field may indicate a beam index or a TCI state identifier of a beam for SRS transmission for a target base station determined in an early beam management process. A cell switch command message may be delivered to a terminal in the form of a MAC CE. The MAC CE of the cell switch command message may be identified through a MAC subheader including an eLCID. Each field may be defined as follows.
Reserved field: The reserved field may be a field indicating reserved bits. The reserved field may be set to 0.
Target configuration identifier field: The target configuration identifier field may be a field indicating an index of a candidate target configuration to be applied to LTM cell switching. The length of the target configuration identifier field may be 3 bits.
Timing advance field: The timing advance command field may be a field indicating validity of a TA for an LTM target cell. When the value of the timing advance command field is ‘FFF’, the timing advance command field may indicate that there is no valid timing adjustment, and otherwise, the timing advance command field may indicate an index value of an applicable timing adjustment. The length of the timing advance command field may be 12 bits.
DL field: The DL field may be a field for informing whether early DL beam management is performed. When the value of the DL field is a first value (e.g. 1), the DL field may indicate that an early DL beam management procedure is performed. When the value of the DL field is a second value (e.g. 0), the DL field may indicate that an early DL beam management procedure is not performed.
UL field: The UL field may be a field for informing whether an early UL beam management procedure is performed. When the value of the UL field is a first value (e.g. 1), the UL field may indicate that an early UL beam management procedure is performed. When the value of the UL field is a second value (e.g. 0), the UL field may indicate that an early UL beam management procedure is not performed.
TCI state identifier field: The TCI state identifier field may be a field indicating a TCI state of an LTM target cell. When the value of the DL field is a first value (e.g. 1), the TCI state identifier field may indicate beam index information or TCI state identifier information of a beam for CSI-RS transmission, which is selected through an early DL beam management procedure. The length of the TCI state identifier field may be 7 bits.
UL TCI state identifier field: The UL TCI state identifier field may be a field indicating a UL TCI state of an LTM target cell. The UL TCI state identifier field may include a case where a unifiedTCI-State Type value is separated. When the value of the UL field is a first value (e.g. 1), the UL TCI state identifier field may indicate beam index information or TCI state identifier information of a beam for SRS transmission, which is selected through an early UL beam management procedure. The length of the UL TCI state identifier field may be 6 bits.
Contention-free random access resource field: The contention-free random access resource field may be a field indicating existence of a contention-free random access resource. When the value is a first value (e.g. 1), the resource may exist, and when the value is a second value (e.g. 0), the resource may not exist.
S/U field: The S/U field may be a 1-bit field indicating a UL carrier used for PRACH transmission other than a contention-free scheme. When the value of the field is a first value (e.g. 1), an SUL may be used, and when the value is a second value (e.g. 0), an NUL may be used. The length of the S/U field may be 1 bit.
Random access preamble index field: The random access preamble index field may be a field indicating a random access preamble index of a contention-free random access resource. The length of the random access preamble index field may be 6 bits.
SS/PBCH index field: The SS/PBCH index field may be a field indicating an SS/PBCH for determining a RACH occasion for PRACH transmission. The length of the SS/PBCH index field may be 6 bits.
PRACH mask index field: The PRACH mask index field may be a field indicating a RACH occasion associated with an SS/PBCH for PRACH transmission. When a repetition count field is not a first value (e.g. 0), the PRACH mask index field may be ignored. The PRACH mask index field may be used only for contention-free PRACH transmission. When the repetition count field is not the first value (e.g. 0), the PRACH mask index field may be ignored because the transmission is contention-based PRACH transmission. The length of the PRACH mask index field may be 4 bits.
Repetition count field: The repetition count field may be a field indicating a repetition count of a message 1 (e.g. Msg1) to be applied to contention-free random access. When the value of the repetition count field is a first value (e.g. 0), a repetition count of Msg1 may not be applied. When the value of the repetition count field is a second value (e.g. 1), the repetition count may be 2, when the value is a third value (e.g. 2), the repetition count may be 4, and when the value is a fourth value (e.g. 3), the repetition count may be 8. The length of the repetition count field may be 2 bits.

The value of the DL field may be the first value (e.g. 0), and the value of the UL field may also be the first value (e.g. 0). In this case, the UL TCI state identifier may be included, for example, when the unifiedTCI-State Type value is separated. When the unifiedTCI-State Type value is not separated, the TCI state identifier field may be a joint UL/DL TCI state identifier. A joint UL/DL TCI state identifier may be a unified TCI state identifier applied to both DL and UL.

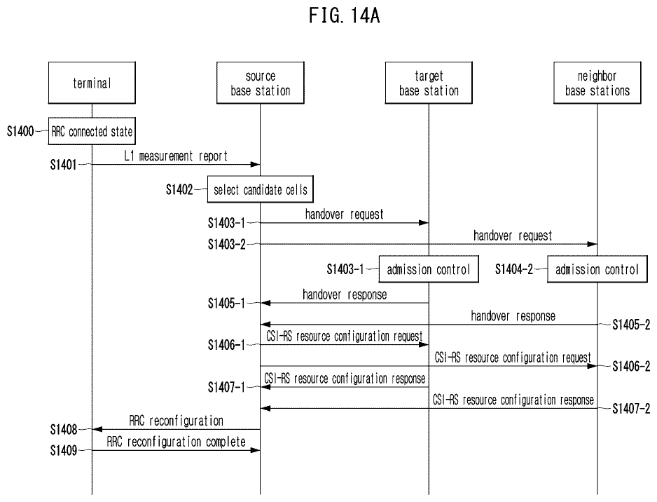

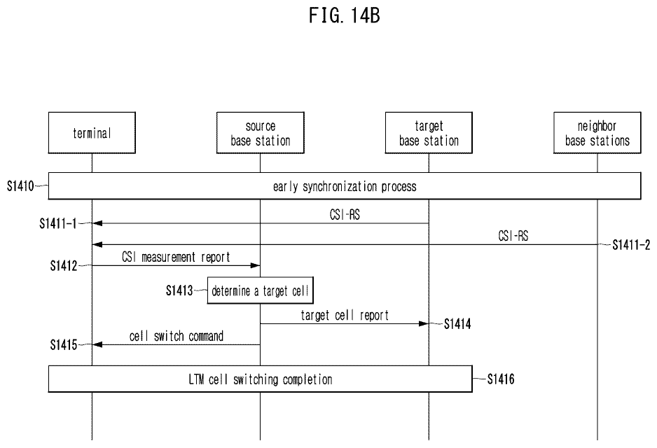

FIG. 14A and FIG. 14B are sequence charts illustrating exemplary embodiments of an early beam management method in a communication system.

Referring to FIG. 14A and FIG. 14B, a terminal and a source base station may be in the RRC connected state (S1400). Neighbor cells of the terminal may broadcast SSBs. The terminal may receive SSBs from the neighbor cells, and may perform SSB-based L1 measurements on the received SSBs to measure signal qualities of the SSBs. The terminal may transmit an SSB-based L1 measurement report message including signal qualities of the measured SSBs to the source base station (S1401). The source base station may receive the SSB-based L1 measurement report message including signal qualities of the measured SSBs from the terminal. The source base station may select candidate cells based on the received signal qualities of the SSBs (S1402). The source base station may select candidate cells by considering various conditions such as a UE capability, a power consumption amount required by the terminal, a movement speed of the terminal, and a QoS level of traffic being served at the terminal. For example, the source base station may reduce power consumption of the terminal and may select about two candidate cells for rapid cell switching as a base station transmitting a best SSB and a base station transmitting a second-best SSB.

The source base station may transmit handover request messages to the selected candidate cells (e.g. including a target base station and other neighbor base stations) (S1403-1, S1403-2). The target base station and other neighbor base stations may receive the handover request messages from the source base station. The target base station and the other neighbor base stations may perform admission control procedures for determining whether to accept the handover request (S1404-1, S1404-2). The target base station and the other neighbor base stations may determine at an upper layer whether they can support traffic sessions of the terminal served by the source base station for handover acceptance. The target base station and the other neighbor base stations may deliver handover response messages indicating that handover is possible to the source base station after performing the admission control procedures (S1405-1, S1405-2). The source base station may receive the handover response messages indicating that handover is possible from the target base station and the other neighbor base stations.

The source base station may transmit CSI-RS resource configuration request messages including CSI-RS transmission requests requesting candidate base stations to transmit CSI-RS (S1406-1, S1406-2). The CSI-RS resource configuration request message may include at least one of information on a beam index or a TCI state identifier of a beam for SSB transmission of the candidate cell. The candidate base stations may receive the CSI-RS resource configuration request messages requesting CSI-RS transmission from the source base station. The candidate base stations may configure/allocate CSI-RS resources capable of CSI-RS transmission. The candidate base stations may deliver CSI-RS resource configuration response messages including configuration information for the configured/allocated CSI-RS resources to the source base station (S1407-1, S1407-2). The configuration information for the CSI-RS resources may include at least one of scheduling information or a scrambling identifier for CSI-RS reception. The source base station may receive the CSI-RS resource configuration response messages including the configuration information on the configured/allocated CSI-RS resources from the candidate base stations. The CSI-RS resource configuration request or response message may include a common CSI-RS set for CSI-RS-based measurement in LTM.

The source base station may transmit an RRC reconfiguration message to the terminal (S1408). The RRC reconfiguration message may include prepared LTM candidate cell configuration information, prepared LTM candidate beam configuration information, information on CSI-RS resources configured/allocated to the LTM candidate cells, and a measurement request for CSI-RS of the LTM candidate cells. Specifically, the RRC reconfiguration message may include configuration information such as beam indexes and physical cell identifier values for the LTM candidate cells or candidate beams. The RRC reconfiguration message may include information on CSI-RS resources configured/allocated to each of the LTM candidate cells, and a measurement request for CSI-RS of each of the LTM candidate cells.

The terminal may receive the RRC reconfiguration message and may store the LTM candidate cell configuration information, the LTM candidate beam configuration information, and the information on CSI-RS resources configured/allocated to the LTM candidate cells. The terminal may transmit an RRC reconfiguration complete message to the base station in response to the RRC reconfiguration message (S1409).

In the early synchronization process of the LTM procedure, the terminal may acquire DL synchronization for an LTM candidate cell before receiving an LTM cell switch command message in order to reduce interruption time. The terminal may acquire UL synchronization (S1410). The early synchronization process of the LTM procedure may not be essential in the LTM procedure. However, when the early synchronization process is not performed in the LTM procedure, an RACH procedure may be required for a candidate cell designated by the base station at the step in which an actual cell switching occurs. The RACH procedure may cause delay.

The early synchronization process of the LTM procedure may use a first synchronization method or a second synchronization method. In the first synchronization method, the terminal may receive synchronization signal blocks (SSBs) from the candidate cells and may obtain timing advance (TA) values based on frame synchronization errors with the base station currently synchronized. In the second synchronization method, the base station may transmit a physical downlink control channel (PDCCH) order to the terminal, and the terminal may receive the PDCCH order from the base station and may obtain TA values for the candidate cells by performing RACH procedures for the candidate cells according to the received PDCCH order.

In the first synchronization method, the terminal may not transmit a separate PRACH preamble to each of the candidate cells. In the first synchronization method, the terminal may not directly receive measurement information from the candidate cells and may have large errors. Through the second synchronization method, the terminal may obtain accurate TA values from the candidate cells. In the second synchronization method, the terminal may receive RAR messages from multiple candidate cells. In the second synchronization method, the terminal may consume a very large amount of downlink resources.

In the second synchronization method, the terminal may maintain the connection with the serving cell. In the second synchronization method, RAR messages of the candidate cells may not be directly delivered to the terminal and may be delivered to the terminal via the source RAR message for reconfiguring the connection with the source base station to the terminal. In the second synchronization method, the source base station may deliver the RAR messages received from the candidate cells to the terminal. The RAR message may include a field for distinguishing an RAR message for re-establishing the connection with the source base station and an RAR message received from the candidate cell. Therefore, the RAR message may not reuse an existing RAR message format.

Each of the candidate base stations may select a beam for CSI-RS transmission corresponding to at least one of the beam index or the TCI state identifier of the beam for SSB transmission received from the source base station, and may transmit CSI-RS to the terminal using the selected beam (S1411-1, S1411-2). The beam for SSB transmission may have a wide beam width. The beam for CSI-RS transmission may have a narrow beam width. A plurality of beams for CSI-RS transmission may be included in one beam for SSB transmission.

The terminal may receive CSI-RSs through the beams from the candidate base stations. The terminal may measure signal quality for each of the received CSI-RSs. The terminal may acquire information on a beam index and a TCI state identifier for each of the beams used for CSI-RS transmission. The terminal may transmit a measurement report message including at least one of information on the signal quality for each of the CSI-RSs, information on the beam index of each of the CSI-RSs, or information on the TCI state identifier of each of the CSI-RSs to the source base station (S1412). The source base station may receive the measurement report message including at least one of the information on the signal quality for each of the CSI-RSs, the information on the beam index of each of the CSI-RSs, or the information on the TCI state identifier of each of the CSI-RSs from the terminal. The source base station may select a target cell based on the signal quality for each of the received CSI-RSs, and select a best beam for the target cell (S1413). The source base station may transmit a target cell report message including at least one of information on a beam index of the selected best beam or information on a TCI state identifier of the selected best beam to the target base station (S1414). The target base station may receive the target cell report message including at least one of the information on the beam index of the best beam or the information on the TCI state identifier of the best beam from the source base station.

Thereafter, the source base station may transmit a cell switch command to the terminal through a MAC CE (S1415). The terminal may receive the cell switch command from the source base station. The terminal may release the connection with the source base station and may complete LTM cell switching by applying a target cell configuration (S1416). The terminal may attempt access by configuring the candidate cell as the target cell. The target base station may select a DL beam based on information on the beam index of the best beam, information on the TCI state identifier of the best beam, or the like, and may deliver data to the terminal using the selected DL beam. The terminal may receive the data from the target base station through the DL beam.

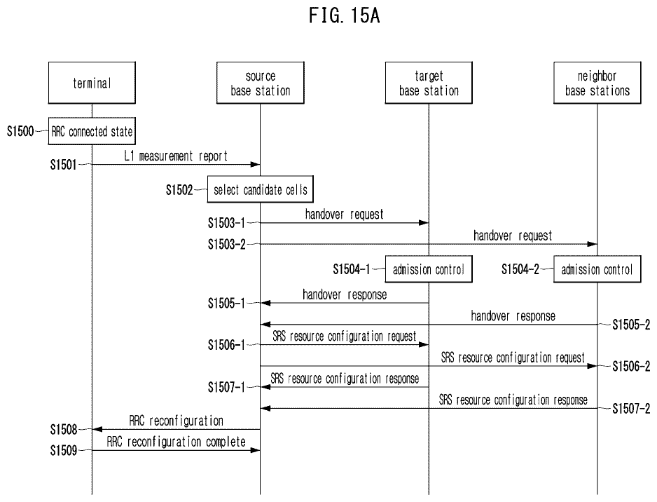

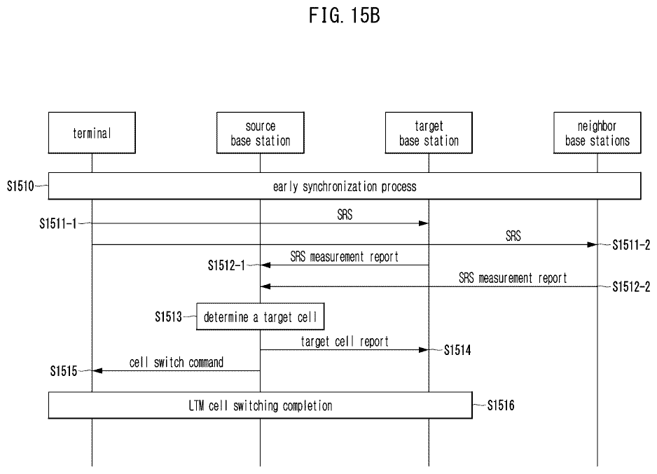

FIGS. 15A and 15B are sequence charts illustrating exemplary embodiments of an early beam management method in a communication system.

Referring to FIGS. 15A and 15B, a terminal and a source base station may be in the RRC connected state (S1500). Neighbor cells of the terminal may broadcast SSBs. The terminal may receive the SSBs from the neighbor cells, and may perform SSB-based L1 measurements on the received SSBs to measure signal qualities of the SSBs. The terminal may transmit an SSB-based L1 measurement report message including the measured signal qualities of the SSBs to the source base station (S1501). The source base station may receive the SSB-based L1 measurement report message including the measured signal qualities of the SSBs from the terminal. The source base station may select candidate cells based on the received signal qualities of the SSBs (S1502). The source base station may select the candidate cells by considering various conditions such as a capability of the terminal, a required power consumption of the terminal, a movement speed of the terminal, and a QoS level of traffic being served at the terminal. For example, the source base station may reduce power consumption of the terminal and, for rapid cell switching, may select two candidate cells including a base station that transmitted a best SSB and a base station that transmitted a second-best SSB.

The source base station may transmit handover request messages to the selected candidate cells (e.g. including a target base station and other neighbor base stations) (S1503-1, S1503-2). The target base station and other neighbor base stations may receive the handover request messages from the source base station. The target base station and the other neighbor base stations may perform admission control procedures for determining whether to accept the handover request (S1504-1, S1504-2). The target base station and the other neighbor base stations may determine at an upper layer whether traffic sessions of the terminal being served by the source base station can be supported for the handover acceptance. The target base station and the other neighbor base stations, after performing the admission control procedures, may deliver handover response messages indicating that handover is possible to the source base station (S1505-1, S1505-2). The source base station may receive the handover response messages indicating that handover is possible from the target base station and the other neighbor base stations.

The source base station may transmit SRS resource configuration request messages including an SRS reception request for requesting the candidate base stations to receive SRSs (S1506-1, S1506-2). The SRS resource configuration request message may include at least one of information on a beam index for a beam for SSB transmission of a candidate cell or information on a TCI state identifier of the beam. The candidate base stations may receive the SRS resource configuration request messages requesting SRS reception from the source base station. The candidate base stations may configure/allocate SRS resources that the terminal is able use to transmit SRS. The candidate base stations may deliver SRS resource configuration response messages including configuration information of the configured/allocated SRS resources to the source base station (S1507-1, S1507-2). The configuration information of the SRS resources may include at least one of scheduling information or a sequence index for SRS transmission. The source base station may receive the SRS resource configuration response messages including the configuration information of the configured/allocated SRS resources from the candidate base stations. The SRS resource configuration request or response message may include a common SRS set for CSI-RS-based measurement in LTM.

The source base station may transmit an RRC reconfiguration message to the terminal (S1508). The RRC reconfiguration message may include prepared LTM candidate cell configuration information, prepared LTM candidate beam configuration information, and information on SRS resources configured/allocated to the LTM candidate cells. Specifically, the RRC reconfiguration message may include configuration information such as beam indexes and physical cell identifier values for the LTM candidate cells or candidate beams. The RRC reconfiguration message may include information on the SRS resources configured/allocated to each of the LTM candidate cells.

The terminal may receive the RRC reconfiguration message and may store the LTM candidate cell configuration information, the LTM candidate beam configuration information, and the information on the SRS resources configured/allocated to the LTM candidate cells. The terminal may transmit an RRC reconfiguration complete message to the base station in response to the RRC reconfiguration message (S1509).

In the early synchronization process of the LTM procedure, the terminal may acquire DL synchronization for an LTM candidate cell before receiving an LTM cell switch command message in order to reduce interruption time. The terminal may acquire UL synchronization (S1510). The early synchronization process of the LTM procedure may not be essential in the LTM procedure. However, when the early synchronization process is not performed in the LTM procedure, an RACH procedure may be required for a candidate cell designated by the base station at the step in which an actual cell switching occurs. The RACH procedure may cause delay.

The early synchronization process of the LTM procedure may use a first synchronization method or a second synchronization method. In the first synchronization method, the terminal may receive synchronization signal blocks (SSBs) from the candidate cells and may obtain timing advance (TA) values based on frame synchronization errors with the base station currently synchronized. In the second synchronization method, the base station may transmit a physical downlink control channel (PDCCH) order to the terminal, and the terminal may receive the PDCCH order from the base station and may obtain TA values for the candidate cells by performing RACH procedures for the candidate cells according to the received PDCCH order.

In the first synchronization method, the terminal may not transmit a separate PRACH preamble to each of the candidate cells. In the first synchronization method, the terminal may not directly receive measurement information from the candidate cells and may have large errors. Through the second synchronization method, the terminal may obtain accurate TA values from the candidate cells. In the second synchronization method, the terminal may receive RAR messages from multiple candidate cells. In the second synchronization method, the terminal may consume a very large amount of downlink resources.

In the second synchronization method, the terminal may maintain the connection with the serving cell. In the second synchronization method, RAR messages of the candidate cells may not be directly delivered to the terminal and may be delivered to the terminal via the source base station. In the second synchronization method, the source base station may deliver an RAR message for reconfiguring the connection with the source base station to the terminal. In the second synchronization method, the source base station may deliver the RAR messages received from the candidate cells to the terminal. The RAR message may include a field for distinguishing an RAR message for re-establishing the connection with the source base station and an RAR message received from the candidate cell. Therefore, the RAR message may not reuse an existing RAR message format.

The terminal may select beams for SRS transmission corresponding to beam indexes and TCI state identifiers of beams for SSB transmission, and may transmit SRSs to the candidate base stations using the selected beams (S1511-1, S1511-2). The beam for SSB transmission may have a wide beamwidth. The beam for SRS transmission may have a narrow beamwidth. A plurality of beams for SRS transmission may be included in one beam for SSB transmission.

The candidate base stations may receive the SRSs from the terminal through the beams. The candidate base stations may measure signal quality for each of the received SRSs. The candidate base stations may acquire information on a beam index or a TCI state identifier for each of the beams used for transmitting the SRSs. The candidate base stations may transmit to the source base station measurement report messages including at least one of information on signal quality for each of the SRSs, information on the beam index of each of the SRSs, or information on the TCI state identifier of each of the SRSs (S1512-1, S1512-2). The source base station may receive from the candidate base stations the measurement report messages including at least one of information on signal quality for each of the SRSs, information on the beam index of each of the SRSs, or information on the TCI state identifier of each of the SRSs. The source base station may select a target cell based on the received signal quality of each of the SRSs and may select a best beam for the target cell (S1513). The source base station may transmit to the target base station a target cell report message including at least one of information on a beam index or a TCI state identifier for the selected best beam (S1514). The target base station may receive the target cell report message including at least one of information on the beam index or the TCI state identifier for the best beam from the source base station.

Thereafter, the source base station may transmit a cell switch command to the terminal through a MAC CE (S1515). The terminal may receive the cell switch command from the source base station. The terminal may release the connection with the source base station and may complete the LTM cell switching by applying a target cell configuration (S1516). The terminal may attempt to access the target cell as the candidate cell. The target base station may select a DL beam based on information on the beam index or the TCI state identifier for the best beam, and may deliver data to the terminal using the selected DL beam. The terminal may receive the data through the DL beam from the target base station. The terminal may select a UL beam based on information on the beam index or the TCI state identifier for the best beam, and may deliver data to the target base station using the selected UL beam. The target base station may receive the data through the UL beam from the terminal.

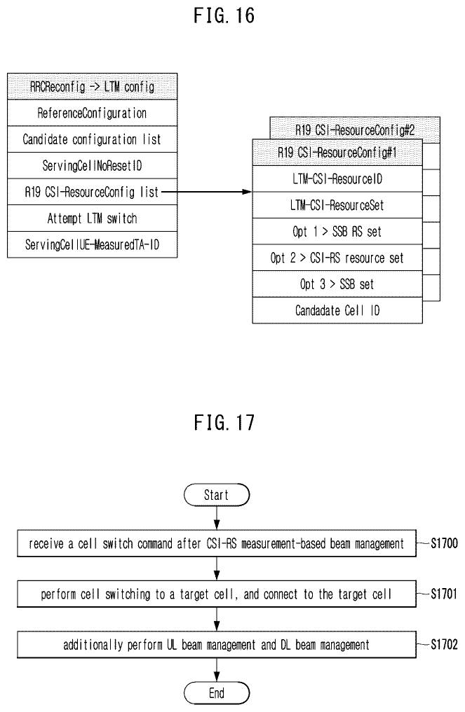

FIG. 16 is a conceptual diagram illustrating exemplary embodiments of configuration information related to DL and UL channel measurement included in a RRC reconfiguration message.

Referring to FIG. 16, an LTM configuration (e.g. LTM config) in an RRC reconfiguration message (e.g. RRCReconfig) may have an R19 CSI resource configuration list (e.g. R19 CSI-ResourceConfig list). Among elements of the R19 CSI resource configuration (e.g. R19 CSI-ResourceConfig), an LTM CSI resource set (e.g. LTM-CSI ResourceSet) may include a CSI-RS resource set and an SRS set in addition to an SSB RS set. When the source base station intends to determine whether a handover event occurs through SSB RS-based measurement, the LTM CSI resource set may include only the SSB RS set.

When the source base station intends to determine whether a handover event occurs through CSI-RS-based measurement, the LTM CSI resource set may include only the CSI-RS resource set. When the source base station intends to determine whether a handover event occurs through SRS-based measurement, the LTM CSI resource set may include only the SRS set. When the source base station intends to determine whether a handover event occurs through DL and UL measurements based on CSI-RS and SRS, the LTM CSI resource set may include both the CSI-RS resource set and the SRS set.

UL traffic and DL traffic may be similar. In such a case, the terminal may perform both UL beam management and DL beam management before cell switching. However, when time is insufficient, the base station may configure a channel state to a joint UL/DL unified TCI state by using complementary characteristics of DL and UL channels (i.e. assumption that UL and DL channel states are similar or identical).

For example, the terminal may measure only a DL channel state, and may apply the measured DL channel state identically to UL. Conversely, the terminal may measure only a UL channel state, and may apply the measured UL channel state identically to DL. The terminal may perform beam management only for DL before cell switching through early beam management, and may perform data transmission and reception by applying a DL beam identically to UL after cell switching. In this manner, the terminal may perform seamless data communication even in the case of inter-CU cell switching. Since a channel state obtained through early beam management may not be the best channel state, additional beam management or beam tracking for DL and UL channels may be performed when performing data communication after cell switching.

When the unifiedTCI-State Type value is not separated, the TCI state identifier field may become a joint UL/DL TCI state identifier and may be applied as a unified TCI state identifier applied to both DL and UL. Therefore, in such a case, the DL field and UL field of the LTM cell switch command MAC CE payload format of FIG. 13 may be configured in reserved states as in the existing case, and only the TCI state identifier field may have meaning.

FIG. 17 is a flowchart illustrating exemplary embodiments of a method for completing cell switching.

Referring to FIG. 17, after CSI-RS measurement-based beam management, the source base station may transmit a cell switch command to the terminal. The terminal may receive the cell switch command from the source base station (S1700). The source base station may configure a unified TCI state with a joint UL/DL TCI state identifier. Traffic of the terminal may be mainly DL traffic. The source base station may acquire a DL TCI state identifier through CSI-RS-based measurement, and may configure the acquired DL TCI state identifier as the joint UL/DL TCI state identifier by using reciprocity of DL and UL channels. The terminal may perform cell switching to a target cell and may be connected to the target cell (S1701). After the cell switching, the terminal may not perform a separate measurement for UL channel, and may use the DL TCI state identifier for UL data transmission. Such a method may not be optimal in terms of throughput. However, for data communication after rapid cell switching, it may be acceptable even if the terminal temporarily uses the method. The terminal may perform seamless data communication. In particular, in the case of inter-CU handover, since the source cell needs to pass through an X interface having a delay of about 10 ms to transmit data to the target cell, a delay of beam management at the target cell may be minimized. The terminal may additionally perform UL beam management and DL beam management in order to provide improved throughput (S1702). The source base station may release the joint UL/DL TCI state identifier applied at the time of cell switching, and may perform association by finding optimal beams having different UL TCI state identifiers and DL TCI state identifiers.

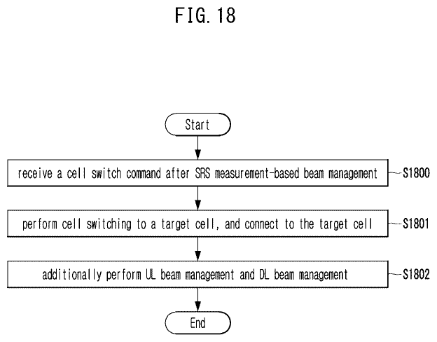

FIG. 18 is a flowchart illustrating exemplary embodiments of a method for completing cell switching.

Referring to FIG. 18, after SRS measurement-based beam management, the source base station may transmit a cell switch command to the terminal. The terminal may receive the cell switch command from the source base station (S1800). The source base station may configure a unified TCI state with a joint UL/DL TCI state identifier. Traffic of the terminal may be mainly UL traffic. The source base station may acquire a UL TCI state identifier through SRS-based measurement, and may configure the acquired UL TCI state identifier as the joint UL/DL TCI state identifier by using reciprocity of DL and UL channels. The terminal may perform cell switching to a target cell and may be connected to the target cell (S1801). After the cell switching, the terminal may not perform a separate measurement for DL channel, and may use the UL TCI state identifier for DL data transmission. Such a method may not be optimal in terms of throughput. However, for data communication after fast cell switching, it may be acceptable even if the terminal temporarily uses the method. The terminal may perform seamless data communication. The terminal may additionally perform UL beam management and DL beam management in order to provide improved throughput (S1802). The source base station may release the joint UL/DL TCI state identifier applied at the time of cell switching, and may perform association by finding optimal beams having different UL TCI state identifiers and DL TCI state identifiers.

The method of performing cell switching by applying only one of the CSI-RS measurement-based beam management or the SRS measurement-based beam management illustrated in FIG. 17 or FIG. 18 may reduce overhead for measurement between the terminal and the base station and may reduce not only power consumption of the terminal but also waste of overall radio resources. However, when both the CSI-RS measurement and the SRS measurement are performed, first-measured information may no longer be the latest information. Moreover, above all, when a movement speed of the terminal is high and fast cell switching is required, time may be insufficient to perform both measurements.

Therefore, even if optimal DL and UL beams are not found in advance, the terminal may perform a measurement corresponding to most dominant traffic and may perform cell switching with the latest beam management information, and may perform DL and UL data communication immediately after performing the cell switching. In other words, when DL has dominant traffic, the terminal may perform the cell switching with the latest beam management information by performing CSI-RS-based measurement and beam management, and may perform DL and UL data communication immediately after performing the cell switching. When UL has dominant traffic, the terminal may perform the cell switching with the latest beam management information by performing SRS-based measurement and beam management, and may perform DL and UL data communication immediately after performing the cell switching.

Through the early beam management procedure proposed in the present disclosure, the terminal can omit beam management after cell switching, and may perform data transmission and reception immediately, thereby reducing data interruption or quality degradation that may occur during handover. In addition, by allowing the terminal to use only one of DL beam management or UL beam management by using channel reciprocity in early beam management, time required for beam management can be reduced, and DL and UL data communication can be performed immediately even after cell switching. Considering that, as a mobile communication frequency band gradually rises to a high frequency of 6 GHz or higher, cell coverage reduction and frequent cell switching occur inevitably in an environment of multiple TRPs, a technology of omitting a beam management procedure after such cell switching may be essential.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving at least one signal from at least one candidate base station;
transmitting a first signal strength measurement result for the at least one signal to a source base station;
performing early downlink (DL) beam management for one candidate base station selected among the at least one candidate base station based on the first signal strength measurement result; and
performing uplink (UL) beam management with the one candidate base station.

2. The method of claim 1, wherein the performing of the early DL beam management for the one candidate base station comprises:
receiving, from the source base station, channel state information-reference signal (CSI-RS) configuration information of the one candidate base station selected based on the first signal strength measurement result;
receiving at least one CSI-RS from the one candidate base station according to the CSI-RS configuration information;
measuring a signal strength for the at least one CSI-RS;
transmitting a second signal strength measurement result for the at least one CSI-RS to the source base station; and
receiving, from the source base station, a beam index of a best CSI-RS selected based on the second signal strength measurement result.

3. The method of claim 1, wherein the performing of the UL beam management with the one candidate base station comprises:
receiving, from the source base station, a sounding reference signal (SRS) transmission request message including scheduling information and a sequence index for SRS transmission;
transmitting at least one SRS to the one candidate base station; and
receiving, from the source base station, information on a beam index of one SRS selected among the at least one SRS.

4. The method of claim 3, wherein the receiving of the information on the beam index of the one SRS selected among the at least one SRS comprises:
receiving at least one of a radio resource control (RRC) message or a medium access control (MAC) control element (CE) of a cell switch command including the information on the beam index of the one SRS.

5. The method of claim 1, further comprising:
receiving, from the source base station, a cell switch command including a unified transmission configuration index (TCI) state configured as a joint UL/DL TCI state identifier;
performing cell switching to the one candidate base station; and
transmitting and receiving signals with the one candidate base station using the joint UL/DL TCI state identifier.

6. A method of a source base station, comprising:
receiving, from a terminal, a first signal strength measurement result of at least one candidate base station;
determining, based on the first signal strength measurement result, to perform early beam management for one candidate base station selected among the at least one candidate base station;
performing downlink (DL) beam management with the terminal and the one candidate base station; and
performing uplink (UL) beam management with the terminal and the one candidate base station.

7. The method of claim 6, wherein the determining to perform early beam management for the one candidate base station selected among the at least one candidate base station comprises:
selecting, based on the first signal strength measurement result, the one candidate base station among the at least one candidate base station to which movement of the terminal is expected;
determining whether the one candidate base station is an inter-central unit (CU) cell; and
based on determining that the one candidate base station is an inter-CU cell, determining to perform early beam management.

8. The method of claim 6, wherein the performing of the DL beam management with the terminal and the one candidate base station comprises:
transmitting, to the one candidate base station, a channel state information-reference signal (CSI-RS) transmission request message for the DL beam management;
receiving, from the one candidate base station, a response message including CSI-RS configuration information in response to the CSI-RS transmission request message;
transmitting the CSI-RS configuration information to the terminal;
receiving, from the terminal, a second signal strength measurement result measured for at least one CSI-RS of the one candidate base station based on the CSI-RS configuration information;
selecting, based on the second signal strength measurement result, a best CSI-RS among the at least one CSI-RS; and
delivering a beam index of the best CSI-RS to the one candidate base station.

9. The method of claim 6, wherein the performing of the UL beam management with the terminal and the one candidate base station comprises:
transmitting, to the one candidate base station, a sounding reference signal (SRS) transmission request message for the UL beam management;
receiving, from the one candidate base station, a response message including scheduling information and a sequence index for SRS reception in response to the SRS transmission request message;
receiving, from the one candidate base station, information on a beam index of one SRS selected among at least one SRS transmitted from the terminal; and
delivering the information on the beam index of the one SRS to the terminal.

10. The method of claim 6, wherein the delivering of the information on the beam index of the one SRS to the terminal comprises: delivering, by the source base station, the information on the beam index of the one SRS using at least one of a radio resource control (RRC) message or a medium access control (MAC) control element (CE) of a cell switch command.

11. The method of claim 6, further comprising: transmitting, to the terminal, a cell switch command including a unified transmission configuration index (TCI) state configured as a joint UL/DL TCI state identifier.

12. A terminal comprising at least one processor, wherein the at least one processor causes the terminal to perform:
receiving at least one signal from at least one candidate base station;
transmitting a first signal strength measurement result for the at least one signal to a source base station;
performing early downlink (DL) beam management for one candidate base station selected among the at least one candidate base station based on the first signal strength measurement result; and
performing uplink (UL) beam management with the one candidate base station.

13. The terminal of claim 12, wherein in the performing of the early DL beam management for the one candidate base station, the at least one processor causes the terminal to perform:
receiving, from the source base station, channel state information-reference signal (CSI-RS) configuration information of the one candidate base station selected based on the first signal strength measurement result;
receiving at least one CSI-RS from the one candidate base station according to the CSI-RS configuration information;
measuring a signal strength for the at least one CSI-RS;
transmitting a second signal strength measurement result for the at least one CSI-RS to the source base station; and
receiving, from the source base station, a beam index of a best CSI-RS selected based on the second signal strength measurement result.

14. The terminal of claim 12, wherein in the performing of the UL beam management with the one candidate base station, the at least one processor causes the terminal to perform:
receiving, from the source base station, a sounding reference signal (SRS) transmission request message including scheduling information and a sequence index for SRS transmission;
transmitting at least one SRS to the one candidate base station; and
receiving, from the source base station, information on a beam index of one SRS selected among the at least one SRS.

15. The terminal of claim 12, wherein the at least one processor further causes the terminal to perform:
receiving, from the source base station, a cell switch command including a unified transmission configuration index (TCI) state configured as a joint UL/DL TCI state identifier, performing cell switching to the one candidate base station; and
transmitting and receiving signals with the one candidate base station using the joint UL/DL TCI state identifier.
